(19) United States
(12) Patent Application Publication
(10) Pub. No.: US 2013/0344200 A1
(43) Pub. Date: Dec. 26, 2013

(54) CHICKEN ESSENCE POWDER AND METHOD FOR MAKING THE SAME

(71) Applicants: Li-Jung YIN, Taipei (TW); Shann-Tzong JIANG, Taipei (TW); Hsueh-Ming TAI, Taipei (TW)

(72) Inventors: Li-Jung YIN, Taipei (TW); Shann-Tzong JIANG, Taipei (TW); Hsueh-Ming TAI, Taipei (TW)

(73) Assignee: NUGEN BIOSIENCE CO., LTD., Taipei (TW)

(21) Appl. No.: 13/528,942

(22) Filed: Jun. 21, 2012

(51) Int. Cl. A23L 1/315

(52) U.S. Cl. 426/63

(57) ABSTRACT

The present invention provides a method of producing chicken essence powder, comprising hydrolyzing the chicken raw material by using the composite protease combining alkaline protease from Bacillus licheniformis with neutral protease from Bacillus subtilis, and spray drying a chicken essence concentration to obtain the chicken essence powder. In addition, the present invention also provides a chicken essence powder produced by the aforementioned method. The chicken essence powder has a particle size ranging from 50 μm to 100 μm, a molecular weight ranging from 200 Da to 2500 Da, and an amount of cholesterol less than 3 milligrams per 100 grams of chicken essence powder. In addition, the present invention also provides a method for scavenging α,α-diphenyl-β-picrylhydrazyl (DPPH) radical by administering the chicken essence powder to a host in need thereof.

### BACKGROUND OF THE INVENTION

1. Field of the Invention

The present invention relates to a chicken essence powder and methods for making the same, and more particularly to a chicken essence powder with high solubility and high nutrient absorption rate.

2. Description of the Prior Arts

Chicken essence is a common liquid nutritional supplement mainly derived from a chicken broth concentrate. It is useful for recovery from mental fatigue, suppressed the elevation of blood pressure and blood glucose. Thus, chicken essence is widely accepted as a popular health-care nutrient supplement nowadays.

A conventional chicken essence is typically obtained by continuous extraction at high temperature under high pressure, which fails to effectively extract the nutrients of chicken. Moreover, the molecular weight of proteins and peptides derived from the chicken are too large to be absorbed and result in low nutrient absorption rate and low bioavailability thereof.

In addition, because the amount of cholesterol of one chicken varies and is hard to be controlled in the production process of chicken essence, the amount of cholesterol contained in the chicken essence product may be too high and thus harmful to the users.

Furthermore, conventional chicken essence is usually stored and sold in a liquid form. However, it is not convenient for travelers to carry with them large amount of chicken essence. Besides, the concentration of chicken essence is not adjustable to fulfill various requirements.

The present invention tries to overcome the above-mentioned problems and provides a method for producing a chicken essence powder with lowered cholesterol level and elevated nutrient absorption rate and bioavailability comparing with the conventional chicken essence.

### SUMMARY OF THE INVENTION

An object of the present invention is to provide a chicken essence powder having several advantages of high solubility, low cholesterol level, high nutrient absorption rate, and an effect of improving immunity.

Another object of the present invention is to provide a portable, highly soluble, and concentration-adjustable chicken essence powder. The chicken essence powder in accordance with the present invention mitigates or obviates the aforesaid shortcomings of the conventional liquid chicken essence.

To achieve the aforementioned objects, the present invention provides a method of producing the chicken essence powder, comprising the steps of:

(A) mixing chicken and water with a weight ratio of chicken to water ranging from 1:0.2 to 1:1.5;

(B) heating the chicken and water to a temperature ranging from 80° C. to 120° C. for 3 hours to 12 hours to obtain a chicken raw material;

(C) mixing the chicken raw material with an amount of alkaline protease from Bacillus licheniformis and an amount of neutral protease from Bacillus subtilis and stirring at a speed ranging from 400 revolutions per minute (rpm) to 500 rpm at a temperature ranging from 30° C. to 60° C. for a hydrolysis period ranging from 3 hours to 12 hours to obtain a hydrolyzing chicken raw material, wherein the amount of alkaline protease from Bacillus licheniformis ranges from 0.5 percentage by weight (% (w/v)) to 2% (w/v) and the amount of neutral protease from Bacillus subtilis ranges from 0.05% (w/v) to 1% (w/v) of the chicken raw material;

(D) heating the hydrolyzing chicken raw material to a temperature ranging from 60° C. to 120° C. for 20 minutes to 80 minutes to obtain a hydrolyzed chicken product;

(E) removing unhydrolyzed chicken raw material and oil from the hydrolyzed chicken product to obtain a purified hydrolyzed chicken product;

(F) adding an excipient into the purified hydrolyzed chicken product with agitation to form a chicken essence concentration; and

(G) spray drying the chicken essence concentration with an inlet temperature ranging from 100° C. to 150° C. and an outlet temperature ranging from 75° C. to 85° C. to obtain the chicken essence powder.

According to the method of the present invention, the step (B) further comprises cooling the chicken and water to 35° C. to 50° C. after heating the chicken and water; and cutting the chicken by shearing machine for 5 minutes to 10 minutes to obtain a chicken raw material to be hydrolyzed in the step (C).

According to the method of the present invention, the step (C) undergoes a hydrolysis reaction in which the chicken raw material is hydrolyzed by using alkaline protease from Bacillus licheniformis and neutral protease from Bacillus subtilis. After hydrolysis reaction of step (C), the large proteins contained in the chicken raw material are hydrolyzed and broken into short peptides and free amino acids, which is so-called “oligo-peptides”. Said oligo-peptides may be di-peptides, tri-peptides or other short polypeptides composed of less than 22 amino acids.

According to the method of the present invention, the composite protease combining alkaline protease from Bacillus licheniformis with neutral protease from Bacillus subtilis provides a stronger hydrolysis ability to destroy the peptide bonds of proteins, and thus most of proteins of the chicken raw material can be hydrolyzed into short peptides. Wherein, the composite protease is stable at a temperature of 30° C. to 60° C.

According to the method of the present invention, the step (D) is considered a step for stopping the hydrolysis reaction of step (C). Preferably, after being hydrolyzed with the composite protease, the hydrolyzed chicken product has a molecular weight ranging from 200 Da to 2500 Da, which is composed of about 1 to 22 amino acids. Because the chicken raw material has been hydrolyzed into several short peptides, the chicken essence powder composed of small oligo-peptides can be more effectively absorbed by user and has higher nutrient absorption rate than the conventional chicken essence.

According to the method of the present invention, the step (E) further comprises removing the unhydrolyzed chicken raw material from the hydrolyzed chicken product by filtration and/or centrifugation. Besides, the step (E) further comprises removing the oil from the hydrolyzed chicken product by oil water separation such as gravity difference method.

Preferably, the excipient is selected from a group consisting of malto-dextrin, starch, lactose, and cornstarch.

According to the method of the present invention, the step (G) further comprises drying the chicken essence powder with low cholesterol level by fluidized bed granulation after spray drying the chicken essence concentration. Preferably, the chicken essence powder has a particle size ranging from 50 micrometer (μm) to 100 μm in diameter.

Besides, the chicken essence powder of the present invention can be formed into liquid-formation chicken essence by mixing with hot water, warm water or chilled water. The chicken essence powder will be dissolved in water without forming precipitation and sedimentation, and turned into a clear amber solution. Thus, this shows that the chicken essence powder of the present invention does have high solubility with water at any temperature.

To achieve the aforementioned objects, the present invention provides a chicken essence powder produced by the aforementioned method. The produced chicken essence powder has a particle size ranging from 50 μm to 100 μm after spray drying process and/or further fluidized bed granulation drying process. The chicken essence powder of the present invention comprises multiple oligo-peptides that have molecular weights ranging from 200 Da to 2500 Da. Wherein, the oligo-peptides are obtained from the chicken raw material hydrolyzed with an alkaline protease from Bacillus licheniformis and a neutral protease from Bacillus subtilis.

Preferably, the chicken essence powder has an amount of cholesterol less than 3 milligrams per 100 grams of chicken essence powder.

To achieve the aforementioned objects, the present invention further provides a method for scavenging DPPH radical, which comprises administering the aforementioned chicken essence powder to a host in need thereof, whereby DPPH radical in the host is reduced.

Accordingly, the chicken essence powder in accordance with the present invention has the following advantages:

(1) Enhanced Nutrient Absorption Rate and Bioavailability:
The chicken raw material is hydrolyzed by using a composite protease comprising alkaline protease from Bacillus licheniformis and a neutral protease from Bacillus subtilis and turned into oligo-peptides each composed of less than 22 amino acids. Thus, the nutrient absorption rate and bioavailability of the chicken essence powder of the present invention will be enhanced.

(2) Low Cholesterol Level:
After separation process of the aforementioned step (E), the chicken essence powder is determined as containing “no cholesterol” by the AOAC 976.26 standard method. The cholesterol detection limit of the AOAC 976.26 standard method is 3 milligrams per 100 grams of chicken essence powder, demonstrating that the chicken essence powder in accordance with the present invention has very low cholesterol level, less than 3 milligrams per 100 grams of chicken essence powder.

(3) Improved Effect of Scavenging α,α-diphenyl-β-picrylhydrazyl (DPPH) Radical:

By lengthening the hydrolysis period of the chicken raw material by using the composite protease, the effect of scavenging DPPH radical of the chicken essence powder can be enhanced. Thus, the immunity of user can be enhanced.

(4) High Solubility:
After spray draying and/or further fluidized bed granulation drying, the chicken essence powder has a particle size less than 100 μm in diameter. Thus, the solubility of chicken essence powder will be enhanced, and the chicken essence powder can be made as an instant soluble product.

Other objectives, advantages and novel features of the invention will become more apparent from the following detailed description when taken in conjunction with the accompanying drawings.

### BRIEF DESCRIPTION OF THE DRAWINGS

FIG. 1 is a graph of soluble protein concentration over the hydrolysis period of the chicken raw materials (before the hydrolysis reaction) and the hydrolyzed chicken products of the example of the present invention and comparative example.

FIG. 2 is a graph of peptide concentration over the hydrolysis reaction of the chicken raw materials (before the hydrolysis reaction) and the hydrolyzed chicken products of the example of the present invention and comparative example.

FIG. 3 is a molecular distribution diagram of the hydrolyzed chicken product of the example in accordance with the present invention.

FIG. 4 is a graph of the effect of scavenging DPPH radical of vitamin C, control sample and the hydrolyzed chicken product of the present invention.

### DETAILED DESCRIPTION OF THE PREFERRED EMBODIMENTS

Hereinafter, one skilled in the arts can easily realize the advantages and effects of the chicken essence powder and its production method in accordance with the present invention from the following embodiments. Therefore, the descriptions proposed herein are just preferable embodiments for the purpose of illustrations only, not intended to limit the scope of the invention. Various modifications and variations could be made in order to practice or apply the present invention without departing from the spirit and scope of the invention.

### PREPARATION EXAMPLE 1

### Preparing the Alkaline Protease From Bacillus licheniformis

First, the Bacillus licheniformis stored at −80° C. was inoculated into 10 ml of fresh Tryptic Soy Broth medium (TSB medium) and incubated at 37° C. for 8 hours to activate Bacillus licheniformis. Then, 1% (w/v) of medium containing the activated Bacillus licheniformis was added into 10 ml of fresh TSB medium and incubated at 37° C. for 8 hours to activate Bacillus licheniformis again.

Subsequently, 0.3 ml of the medium containing the activated Bacillus licheniformis was inoculated into 30 ml of fresh TSB medium at 37° C. with agitation for 8 hours, and then inoculated into a fermentation tank and incubated for 46 hours to induce the production of alkaline protease from Bacillus licheniformis.

The medium containing alkaline protease from Bacillus licheniformis was dried by spray drying, and finally obtains the alkaline protease powder from Bacillus licheniformis.

### PREPARATION EXAMPLE 2

### Preparing the Neutral Protease From Bacillus subtilis

First, Bacillus subtilis stored at −80° C. was inoculated into 10 ml of fresh TSB medium and incubated at 37° C. for 8 hours to activate Bacillus subtilis. Then, 1% (w/v) of medium containing the activated Bacillus subtilis was added into 10 ml of fresh TSB medium and incubated at 37° C. for 8 hours to activate Bacillus subtilis again.

Subsequently, 0.3 ml of the medium containing the activated Bacillus subtilis was inoculated into 30 ml of fresh TSB medium at 37° C. with agitation for 12 hours, and then was inoculated into a fermentation tank and incubated for 46 hours to induce the production of neutral protease from Bacillus subtilis.

The medium containing neutral protease from Bacillus subtilis was dried by spray drying, and finally obtains the neutral protease powder from Bacillus subtilis.

### EXAMPLE

### Producing Chicken Essence Powder with Alkaline protease from Bacillus licheniformis and the Neutral Protease From Bacillus subtilis

Local fresh chickens in Taiwan were provided. First, the local fresh chickens were pre-treated to remove their skin and bones. The pre-treated local fresh chickens were cut into lumps of chicken.

Then, lumps of chicken were mixed with water at a weight ratio of chicken to water ranging from 1:0.2 to 1:1.5 in 100 liter of bioreactor. After that, the bioreactor was heated to a temperature ranging from 80° C. to 120° C. for 3 hours to 12 hours. The mixed chicken and the water was cooled to 35° C. to 50° C. after heating the chicken and water, and the chicken was cut by shearing machine for 5 minutes to 10 minutes to obtain the chicken raw material.

Subsequently, the chicken raw material was stirred at 30° C. to 60° C. and at 400 rpm to 500 rpm, and 0.5% to 2% (w/v) of alkaline protease from Bacillus licheniformis prepared by Preparation Example 1 and 0.05% to 1% (w/v)of neutral protease from Bacillus subtilis prepared by Preparation Example 2 were added into the chicken raw material to undergo a hydrolysis reaction for 3 hours to 12 hours. The hydrolyzing chicken raw material was heated to 60° C. to 120° C. for 20 minutes to 80 minutes to stop the hydrolysis reaction. Then, a hydrolyzed chicken product was obtained.

After that, the hydrolyzed chicken product was filtered with a sieve to remove the undesired bone fragments and residues, and the hydrolyzed chicken product was purified by using a continuous centrifuge to remove the solid substances, e.g. unhydrolyzed chicken raw material comprising high molecular weight proteins, from the hydrolyzed chicken product. Then, oil contained in the hydrolyzed chicken product was further removed by oil water separation. Other impurities were also removed by using a concentrator with membrane pores ranging from 0.22 μm to 10 μm. The filtered chicken essence is collected from the concentrator and stored in an ice bath to obtain a purified hydrolyzed chicken product.

Then, an excipient such as malto-dextrin, starch, lactose, or cornstarch was added into the purified hydrolyzed chicken product with agitation to form a chicken essence concentration. The chicken essence concentration was dried by spray drying with an inlet temperature ranging from 100° C. to 150° C. and an outlet temperature ranging from 75° C. to 85° C. to obtain the chicken essence powder having particle sizes ranging from 50 μm to 100 μm.

### COMPARATIVE EXAMPLE

### Producing Chicken Essence Powder with Neutral Protease From Bacillus subtilis

In the comparative example, the method of producing the chicken raw material was implemented as described in the example of the present invention.

In the comparative example, the obtained chicken raw material was stirred at 30° C. to 60° C. and at 400 rpm to 500 rpm, and 0.05% to 1% (w/v) of neutral protease from Bacillus subtilis prepared by Preparation Example 2 was added into the chicken raw material to perform a hydrolysis reaction for 3 to 12 hours. The hydrolyzing chicken raw material was heated to 60° C. to 100° C. for 20 minutes to 80 minutes to stop the hydrolysis reaction. A hydrolyzed chicken product was obtained.

### Test Example 1

### Hydrolysis Ability of Proteases

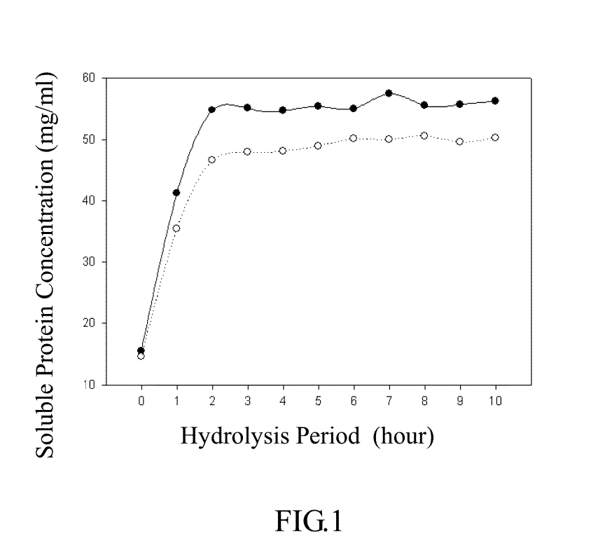

As shown by FIG. 1, the soluble protein concentration of the example was about 15.6 mg/ml before the hydrolysis reaction. After 2 hours hydrolysis reaction, the soluble protein concentration was gradually increased. The soluble protein concentration of the hydrolyzed chicken product of the example was significantly increased to 56.2 mg/ml after 10 hours hydrolysis reaction. However, the soluble protein concentration of the hydrolyzed chicken product of comparative example 1 was only 50.6 mg/ml after 2 hours to 10 hours of hydrolysis reaction.

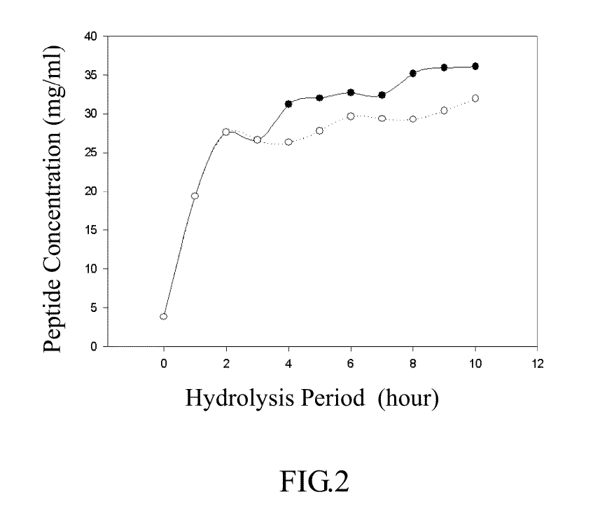

As shown by FIG. 2, the peptide content of the example was only about 3.82 mg/ml before hydrolysis reaction. After 10 hours hydrolysis reaction, the peptide content was gradually increased to 36.1 mg/ml. However, the peptide content of the hydrolyzed chicken product of comparative example 1 was only 31.5 mg/ml after 4 hours to 10 hours hydrolysis reaction.

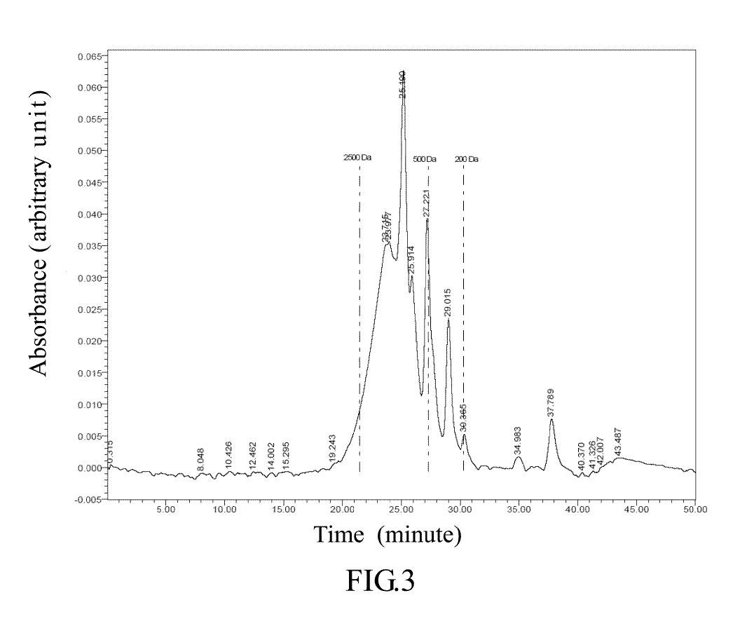

As shown by FIG. 3, the molecular weights of the oligo-peptides contained in the hydrolyzed chicken product were about 200 Da to 2500 Da, almost 1 to 22 amino acids.

The results have demonstrated that the composite protease combining alkaline protease from Bacillus licheniformis with neutral protease from Bacillus subtilis does effectively destroy the peptide bonds of large proteins, and obtain a hydrolyzed chicken product (having molecular weight less than 2500 Da) with higher soluble protein concentration and higher peptide content. Thus, the nutrient absorption rate and bioavailability of chicken essence powder of the present invention were enhanced.

### Test Example 2

### Effect of Scavenging DPPH Radical

The effect of scavenging DPPH radical was tested by the following experiment.

In the test example, 0.2 grams of chicken essence powder produced by the example of the present invention was added into 1 ml of water, and 1 ml of 1M DPPH solution (dissolved in 95 vol % of ethanol) was subsequently added into the aforementioned solution at room temperature (about 25 to 37° C.) for 30 min.

The absorbance of the sample at OD 517 nm was measured. The higher absorbance represents a higher hydrogen-donating capacity of the anti-oxidant, i.e. a stronger effect of scavenging DPPH radical. Wherein, the percentage of scavenging DPPH radical effect was calculated by the following equation:

scavenging DPPH radical effect (%)=[1-(absorbance of sample/absorbance of control)×100%

Referring to the disclosure of Shimada K, Fujikawa K, Yahara K and Nakamura T (1992) “Ntioxidative properties of xanthan on the autoxidation of soybean oil in cyclodextrin emulsion.” J. Agric. Food Chem. 40:945-948, vitamin C (L-ascorbic acid) was used as a positive control of the test example. In addition, the aforementioned composite protease was heated to 100° C. for 30 minutes to inhibit the activity of composite protease. The non-active composite protease was used as a control of the test example.

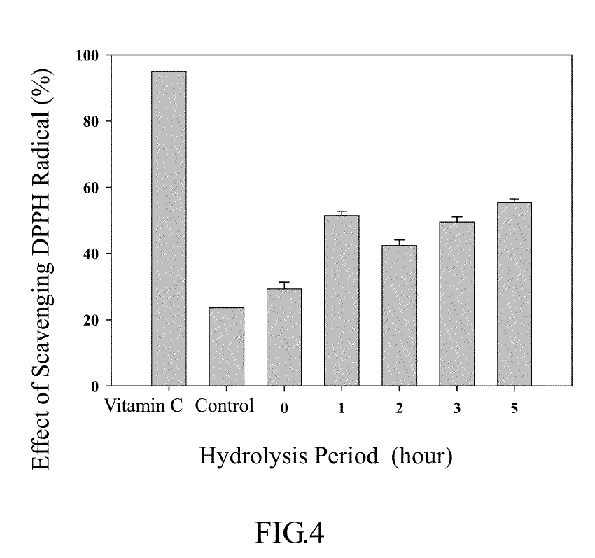

As shown by FIG. 4, 100 μg of vitamin C had a DPPH radical scavenging effect about 93.27%. The non-active composite protease (control sample) only had a DPPH radical scavenging effect about 24%. The chicken essence powder had an improved DPPH radical scavenging effect as the hydrolysis period was lengthened. The chicken essence powder of the present invention, which was hydrolyzed by active composite protease for 5 hours, had a DPPH radical scavenging effect about 55%. The results show that the short peptides and free amino acids, which were derived from the chicken raw material hydrolyzed with the active composite protease, do provide a stronger DPPH radical scavenging effect than large protein and non-active composite protease, and thereby the antioxidant and immune abilities were enhanced.

### Test Example 3

### Cholesterol Level of Chicken Essence Powder

The cholesterol level of chicken essence powder was tested by Taiwan Food Industry Research and Development Institute according to AOAC 976.26 standard method. The detailed process of the standard method is available on http://www.aoac.org/. If the cholesterol content was less than 3 milligrams per 100 grams of chicken essence powder, the chicken essence powder was determined as containing “no cholesterol” by the AOAC 976.26 standard method.

In the test example, the chicken essence powder was determined as containing no cholesterol. The result shows that cholesterol contained in the chicken essence powder was effectively removed by the present method. A chicken essence powder with low cholesterol level of the present invention was produced.

### Test Example 4

### Fat Content of Chicken Essence Powder

The cholesterol level of chicken essence powder was tested by Taiwan Food Industry Research and Development Institute according to CNS 5036§2.3 standard method. The detailed process of the standard method is available on http://www.cnsonline.com.tw/. The test shows that 33.3 grams of saturated fatty acid was contained in every 100 grams of fat. The chicken essence powder was determined as containing no saturated fats, trans-fats, and crude fats according to CNS 5036§2.3 standard method. Thus, the chicken essence of the present invention also had a low fat level.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of producing chicken essence powder, comprising the steps of:
(A) mixing chicken and water with a weight ratio of chicken to water ranging from 1:0.2 to 1:1.5;
(B) heating the chicken and water to a temperature ranging from 80° C. to 120° C. for 3 hours to 12 hours to obtain a chicken raw material;
(C) mixing the chicken raw material with an amount of alkaline protease from Bacillus licheniformis and an amount of neutral protease from Bacillus subtilis and stirring at a speed ranging from 400 rpm to 500 rpm at a temperature ranging from 30° C. to 60° C. for a hydrolysis period ranging from 3 hours to 12 hours to obtain a hydrolyzing chicken raw material, wherein the amount of alkaline protease from Bacillus licheniformis ranges from 0.5% (w/v) to 2% (w/v) and the amount of neutral protease from Bacillus subtilis ranges from 0.05% (w/v) to 1% (w/v) of the chicken raw material;
(D) heating the hydrolyzing chicken raw material to a temperature ranging from 60° C. to 120° C. for 20 minutes (min) to 80 minutes to obtain a hydrolyzed chicken product;
(E) removing unhydrolyzed chicken raw material and oil from the hydrolyzed chicken product to obtain a purified hydrolyzed chicken product;
(F) adding an excipient into the purified hydrolyzed chicken product with agitation to form a chicken essence concentration; and
(G) spray drying the chicken essence concentration with an inlet temperature ranging from 100° C. to 150° C. and an outlet temperature ranging from 75° C. to 85° C. to obtain the chicken essence powder.

2. The method of producing chicken essence powder as claimed in claim 1, wherein the step (B) further comprises cooling the chicken and water to 35° C. to 50° C. after heating the chicken and water; and cutting the chicken by shearing machine for 5 minutes to 10 minutes to obtain the chicken raw material.

3. The method of producing chicken essence powder as claimed in claim 1, wherein the hydrolyzed chicken product has a molecular weight ranging from 200 Da to 2500 Da.

4. The method of producing chicken essence powder as claimed in claim 1, wherein the step (E) further comprises removing the unhydrolyzed chicken raw material from the hydrolyzed chicken product by filtration and/or centrifugation.

5. The method of producing chicken essence powder as claimed in claim 1, wherein the step (E) further comprises removing the oil from the hydrolyzed chicken product by oil water separation.

6. The method of producing chicken essence powder as claimed in claim 1, wherein the excipient is selected from a group consisting of malto-dextrin, starch, lactose, and cornstarch.

7. The method of producing chicken essence powder as claimed in claim 1, wherein the step (G) further comprises drying the chicken essence powder with low cholesterol level by fluidized bed granulation after spray drying the chicken essence concentration.

8. The method of producing chicken essence powder as claimed in claim 1, wherein the chicken essence powder with low cholesterol level has an effect of scavenging DPPH radical.

9. A chicken essence powder produced by the method as claimed in claim 1, wherein the chicken essence powder has a particle size ranging from 50 μm to 100 μm.

10. The chicken essence powder as claimed in claim 9, wherein the chicken essence powder comprises multiple oligo-peptides having molecular weights ranging from 200 Da to 2500 Da.

11. The chicken essence powder as claimed in claim 9, wherein the chicken essence powder has an amount of cholesterol less than 3 milligrams per 100 grams of chicken essence powder.

12. The chicken essence powder as claimed in claim 9, wherein the chicken essence powder has an effect of scavenging DPPH radical.

13. A method for scavenging DPPH radical, which comprises administering the chicken essence powder as claim 9 to a host in need thereof, whereby DPPH radical in the host is reduced.
